(19) United States
(12) Patent Application Publication
(10) Pub. No.: US 2016/0073328 A1
(43) Pub. Date: Mar. 10, 2016

(54) METHOD AND APPARATUS FOR DETERMINING PCRF

(71) Applicant: ALCATEL LUCENT, Paris (FR)

(72) Inventors: Xiangyang LI, Shanghai (CN); Yigang CAI, Naperville, IL (US)

(73) Assignee: Alcatel Lucent, Boulogne-Billancourt (FR)

(21) Appl. No.: 14/786,745

(22) PCT Filed: May 12, 2014
(86) PCT No.: PCT/IB2014/001288

§ 371 Date: Oct. 23, 2015

(30) Foreign Application Priority Data
Jun. 7, 2013 (CN) 201310225997.6

(51) Int. Cl. H04W 48/14; H04W 8/20; H04W 8/12

(52) U.S. Cl. CPC H04W 48/14; H04W 8/12; H04W 8/205

(57) ABSTRACT

First, correspondence relationships between subscribers and PCRFs are preset in HSS, and a same PCRF is configured to subscribers belonging to the same subscriber group. Then, the MME or AF or 3GPP AAA server sends a query message to HSS, obtains the PCRF corresponding to a certain subscriber, and then sends the PCRF information to S-GW or P-GW or ePDG. In this way, S-GW or P-GW or ePDG may send messages related to the same subscriber or the same subscriber group to the same PCRF. A network element may send to the same PCRF messages related to the same subscriber or the same subscriber group as required to be sent to the PCRFs, such that the same PCRF performs a uniform control to all related sessions of the same subscriber or the same subscriber group.

### FIELD OF THE INVENTION

The present invention relates to the field of communications technology, and more specifically, to a technique of PCRF selection.

### BACKGROUND OF THE INVENTION

The PCC (Policy and Charging Control) architecture as defined in 3GPP standard is mainly shown in FIG. 1. Hereinafter, several functions and interfaces therein associated with the present invention will be briefly introduced.

Policy and Charging Rule Function (PCRF), which has functions of policy control decision and flow-based charging control, provides a Policy and Charging Enforcement Function (PCEF) with network control functions in terms of traffic data flow detection, gate control, QoS-based and flow-based charging (excluding credit control). When a subscriber is roaming, intercommunication between visit PCRF and home PCRF is required so as to provide services to the subscriber; therefore, the PCRF may be divided into H-PCRF (Home PCRF) and V-PCRF (Visit PCRF) functions.

Policy and Charging Enforcement Function (PCEF), which is in charge of traffic data flow detection, policy enforcement, and flow-based charging function, is generally provided on a GGSN (Gateway GPRS Support Node) or P-GW (PDA (Packet Data Network)-GateWay).

Application Function (AF), which mainly performs dynamic policy or charging control to an IP-CAN (IP-Connectivity Access Network) subscriber plane behavior, is provided on a service platform.

Subscription Profile Repository (SPR), which is logic entity storing information about all subscribers or subscription-related information, including allowed traffic for the subscribers, is generally provided on a Home Subscriber Server (HSS).

Traffic Detection Function (TDF), used for detecting an application and reporting the detected application and a description of its traffic data flow to the PCRF.

FIG. 1 shows that PCRF is crucial in the PCC architecture. In FIG. 1, various functionalities mainly interact with the PCRF through the following interfaces.

Gx interface: located between PCRF and PCEF, for transferring the policy and charging rule. This interface supports transfer of SDF (Service Data Flow)-level PCC information and of wireless access technical information and location information.

Rx interface: located between AF and PCRF, for transferring application layer information from the AF, including differential charging information, media/application bandwidth demand for QoS control, etc.

Sp Interface: located between SPR and PCRF, for the PCRF to obtain IP-CAN transfer policy-related subscriber information from the SPR, for example, subscriber ID, PDN identification, etc.

Sd interface: located between TDF and PCRF, for the PCRF to perform dynamic control of application detection and control of TDF behaviors.

S9 interface: located between H-PCRF and V-PCRF, for supporting transfer of SDF-level PCC information in a roaming scenario and transfer of QoS parameters, relevant packet filter and control information in a non-roaming scenario.

A plurality of PCRFs would be deployed in a network. For a network element interacting with a PCRF, there would be a problem of how to select the PCRF.

For an IP-CAN session, in order to facilitate management, the network element processing the session must transmit all Diameter messages related to the session to the same PCRF, such that the PCRF performs the same policy and charging control to the session.

In the case of a subscriber group, since the subscriber imposes the same policy and requirement on the members therein, usage control for these subscribers should be performed by the same PCRF.

In the case of MTC (Machine Type Communication), when a plurality of machines form a group, the same PCRF is likewise required to guarantee that these machines use the same policy. However, these machines always belong to different service providers and are located in different locations. Therefore, it is also an issue how to enable relevant network elements to select the same PCRF.

The 3GPP also proposes some solutions of selecting a PCRF. An optional network element DRA (Diameter Routing Agent), as introduced in the 3GPP TS 23.203 version 11.7.0 formulated in September 2011, is dedicated for selecting and determining a PCRF, so as to guarantee that all Diameter messages related to the same IP-CAN session can reach the same PCRF. The concept of group PCRF, as introduced in the 3GPP TS 23.858 version 1.1.0 formulated in November 2012, is for monitoring and controlling a subscriber group. The group PCRF substantively refers to a PCRF performing uniform control to the members in the group.

However, all of these methods have different problems.

First, DRA is an optional network element, and not all operators are deployed with the DRA. When a network is not deployed with a DRA, selection and determination of the PCRF would become a problem. Second, even if the network is deployed with a DRA, since the DRA is located between the PCRF and other network elements, there is also a problem of how to select a route to reach the DRA for these elements. Further, for the scenario of MTC group, since these machines always belong to different service providers and are located in different locations, the DRA does not necessarily have the information for routing these machines to the same PCRF.

The solutions for the group PCRF as proposed in 3GPP are mainly divided into two kinds One is leveraging DRA, which cannot solve problems for those operators without deploying DRA. The other kind does not use DRA; however, this method needs a multiple times of interactions between the PCRF and the PCEF, which results in too many messages and is too complex.

Therefore, it is desirable to provide a new method of selecting and determining PCRF.

### SUMMARY OF THE INVENTION

An objective of the present invention is to provide a method and apparatus for selecting and determining PCRF.

According to the first aspect of the invention, a method of determining PCRF in a first network server is provided, said first network server storing information related to subscribers, the method comprises the following steps: receiving a first request message containing identification information of a subscriber from a second network server; determining a PCRF corresponding to the subscriber based on preset correspondence relationships between subscribers and PCRFs; sending a first reply message containing identification information of the determined PCRF to said second network server; wherein, said first network server pre-stores the correspondence relationships between subscribers and PCRFs.

Preferably, said first network server is a Home Subscriber Server (HSS) or Subscriber Profile repository (SPR), said second network server is a mobility management entity (MME) or an application function (AF) or a 3GPP AAA server.

According to the second aspect of the invention, a method of determining PCRF in a second network server is provided, the method comprises the following steps: sending a first request message containing identification information of a subscriber to a first network server; receiving a first reply message containing identification information of the PCRF corresponding to the subscriber from the first network server; wherein, said first network server pre-stores correspondence relationships between subscribers and PCRFs.

Preferably, said first network server is a Home Subscriber Server (HSS) or Subscriber Profile repository (SPR), said second network server is a mobility management entity (MME) or an application function (AF) or a 3GPP AAA server.

Preferably, when said second network server is a mobility management entity (MME) or a 3GPP AAA server, the step of sending a first request message to said first network server further comprises: sending a first request message to the first network server in response to an attachment request from the subscriber.

Preferably, when said second network server is a mobility management entity (MME) or a 3GPP AAA server, after said step of receiving a first reply message from the first network server, it further comprises: sending a second request message containing said identification information of the subscriber and identification information of the PCRF to a third network server.

Preferably, said third network server is a Service Gateway (S-GW) or a Packet Data Network Gateway (P-GW) or an Evolved Packet Data Gateway (ePDG).

According to the third aspect of the invention, an apparatus of determining PCRF in a first network server is provided, said first network server stores information related to subscribers, the apparatus comprises: a first receiving device for receiving a first request message containing identification information of a subscriber from a second network server; a determining device for determining a PCRF corresponding to the subscriber based on preset correspondence relationships between subscribers and PCRFs; a first sending device for sending a first reply message containing identification information of the determined PCRF to said second network server; wherein said first network server pre-stores the correspondence relationships between subscribers and PCRFs.

Preferably, said first network server is a Home Subscriber Server (HSS) or Subscriber Profile Repository (SPR), said second network server is a Mobility Management Entity (MME) or an Application Function (AF) or a 3GPP AAA server.

According to the fourth aspect of the invention, an apparatus of determining PCRF in a second network server is provided, the apparatus comprises: a second sending device for sending a first request message containing identification information of a subscriber to a first network server; a second receiving device for receiving a first reply message containing identification information of the PCRF corresponding to said subscriber from said first network server; wherein, said first network server pre-stores correspondence relationships between subscribers and PCRFs.

Preferably, said first network server is a Home Subscriber Server (HSS) or Subscriber Profile Repository (SPR), the second network server is a Mobility Management Entity (MME) or an Application Function (AF) or a 3GPP AAA server.

Preferably, when said second network server is a Mobility Management Entity (MME) or a 3GPP AAA server, said second network server is also used for sending a first request message to the first network server in response to an attachment request from said subscriber.

Preferably, when said second network server is a Mobility Management Entity (MME) or a 3GPP AAA server, said apparatus comprises a third sending device, used for sending a second request message containing identification information of the subscriber and identification information of the PCRF to a third network server after the step of the second receiving device receiving a first reply message from said first network server.

Preferably, said third network server is a Service Gateway (S-GW) or a Packet Data Network Gateway (P-GW) or an Evolved Packet Data Gateway (ePDG).

Compared with the existing methods of selecting PCRF, the present invention has the following advantages: (1) without the need of introducing new network elements; (2) without the need of adding new interface; (3) without the need of changing the message flow, without increasing the complexity. By adopting the method according to the present invention, a network element in the network may send the messages that are required to be sent to PCRFs by the same subscriber or the same subscriber group to a same PCRF, such that the same PCRF perform uniform control to all relevant sessions of the same subscriber or the same subscriber group.

### BRIEF DESCRIPTION OF THE SEVERAL VIEWS OF THE DRAWINGS

Through reading the following detailed depiction on the non-limiting embodiments with reference to the accompanying drawings, other features, objectives, and advantages of the present invention will become more apparent.

FIG. 1 shows a diagram of PCC architecture as defined in 3GPP;

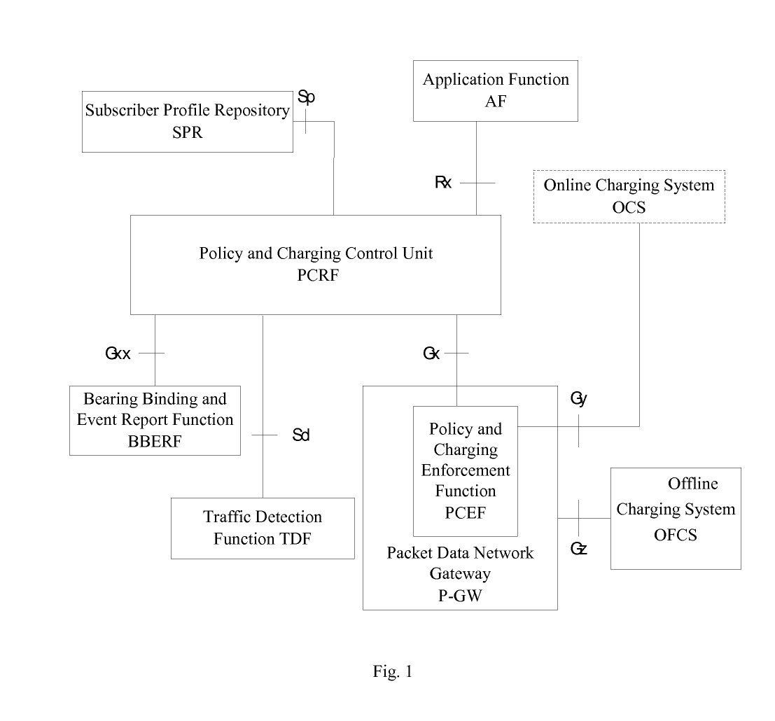

FIG. 2 shows a diagram of an application scenario of one embodiment of the present invention;

FIG. 3 shows a flow chart of a method of determining PCRF according to one embodiment of the present invention;

FIG. 4 shows a flow chart of a process of determining PCRF according to one embodiment of the present invention;

FIG. 5 shows a flow chart of a process of determining PCRF according to another embodiment of the present invention;

FIG. 6 shows a diagram of an apparatus for determining PCRF according to one embodiment of the present invention;

FIG. 7 shows a diagram of an apparatus for determining PCRF according to one embodiment of the present invention.

Same or like reference numerals in the accompanying drawings indicate the same or corresponding components.

### DETAILED DESCRIPTION OF THE INVENTION

Hereinafter, the present invention will be further described in detail with reference to the accompanying drawings.

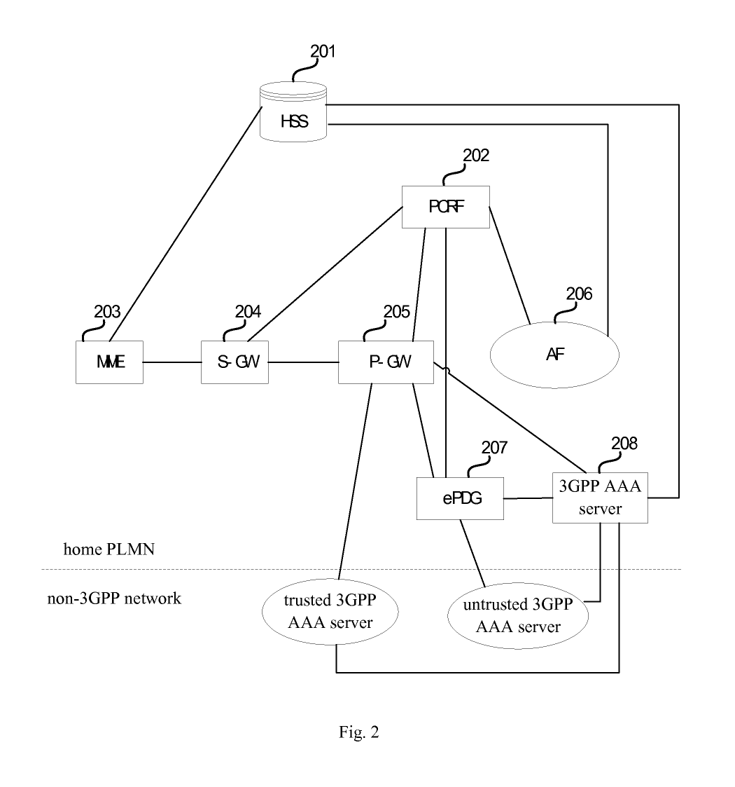

FIG. 2 shows a diagram of an application scenario of one embodiment of the present invention. FIG. 2 exemplarily shows a home PLMN (Public Land Mobile Network) belonging to a 3GPP network and a non-3GPP network. UE (User Equipment) may access either through the 3GPP network or through a non-3GPP network. The non-3GPP network access includes trusted non-3GPP access and non-trusted non-3GPP access.

The functions of major network elements in FIG. 2 are specified below:

HSS201: a database for storing subscriber subscription information, in charge of saving information about subscribers, including: subscriber identifier, route information, subscriber security information, subscriber location information, etc. HSS201 is a major subscriber database in the LTE network.

PCRF202: the functions of PCRF have been introduced in the background. Multiple PCRFs may be set in the home PLMN network.

MME (Mobility Management Entity) 203: is key control node of the LTE access network. It is responsible for idle mode UE track and paging control. These contents also include UE registration and log-off process, and meanwhile help UE to select different S-GWs to perform LTE system core network (CN) node handover. Through information exchange with HSS201, the MME203 may also perform a subscriber authentication function. The MME 203 also provides mobility management of the LTE and 2G/3G access network control plane function. The MME also supports performing a roaming service between UE and HSS via S6A interface.

S-GW (Serving-GateWay) 204: located in the subscriber plane, and for each UE accessing to the LTE network, it is only served by one S-GW each time. Its major functions are to perform session management, routing selection, and data forwarding, QoS control, charging, and storage information, etc.

P-GW205: located in the subscriber plane, a facing PDN gateway. If the UE accesses multiple PDNs, the UE would correspond to one or more P-GWs. Its main functions include IP address allocation, session management, PCRF selection, routing selection, data forwarding, QoS control, charging, policy and policy enforcement, etc. The PGW205 plays another crucial role of a core component for data exchange, which bears the data exchange between 3GPP and non-3GPP networks, for example, with WiMAX and 3GPP2 (CDMA1× and EVDO) networks.

AF206: mainly referring to an operator's IP service, for example, IMS (IP Multimedia Subsystem), PSS (PSTN/IDSN Simulation Services), etc.

ePDG (Evolved Packet Data Gateway) 207: its main function is to guarantee the UE for data transfer to be connected to the 3GPP network through untrusted non-3GPP access network. For this purpose, it is required to establish an IPsec (IP Security) tunnel between the ePDG and the UE.

3GPP AAA (Authentication-Authorization-Accounting) server 208: its main objective is to manage which subscribers may access the network server, what services the authorized subscribers can obtain, and how to account the subscriber currently using the network resources.

It should be noted that FIG. 2 merely shows the network elements and connections involved in the present invention; those skilled in the art should understand that in order to implement the present invention, other necessary network elements and connections are further needed. For the convenience of depiction, they are not shown here.

HSS201 is a central database storing subscriber configuration information. Generally, one subscriber corresponds to one configuration file. The present invention presets PCRF information corresponding to the subscribers in these configuration files, for indicating a PCRF corresponding to a subscriber. Here, the PCRF information may be the name of the PCRF or address or other forms of identification information.

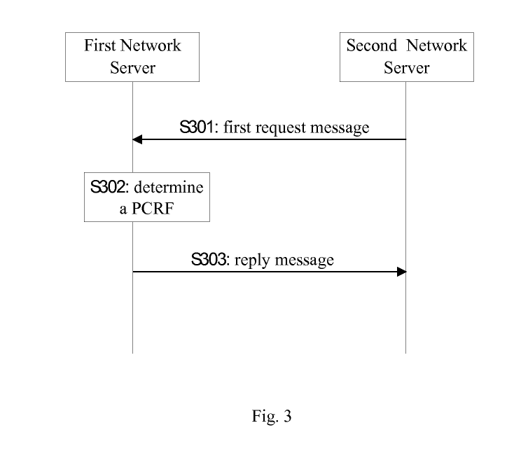

FIG. 3 shows a flow chart of a method of determining PCRF according to one embodiment of the present invention. In this embodiment, a first network server stores subscriber-relevant information. Such information includes preset correspondence information between the subscribers and the PCRFs, i.e., which PCRF each subscriber corresponds to; for subscribers belonging to the same subscriber group, they correspond to the same PCRF. In one embodiment, the first network server is HSS201. Those skilled in the art should understand that the first network server may also be other network element storing subscriber information, for example, SPR, etc.

The method starts from step S301. In step S301, the first network server receives a first request message including identifier information of a subscriber from the second network server. The second network server, sending the request message to the first network server so as to obtain PCRF, may be MME203 or AF206 or 3GPP AAA server 208.

In step S302, the first network server determines the PCRF corresponding to the subscriber based on the subscriber's identification information and the preset correspondence relationship between subscribers and PCRFs.

In step S303, the first network server sends a first reply message including the identification information of the determined PCRF to the second network server. The second network server may use the PCRF information where necessary, i.e., sending the PCC request related to the subscriber to the PCRF. For example, for AF 206, the network elements in the IMS may send the message related to a certain subscriber to the same PCRF so as to guarantee that QoS and IP bearer are controlled by the same PCRF.

In one embodiment, said second network server is MME203 or 3GPP AAA server 208; step S301 further comprises: in response to an attachment request from the subscriber, said second network server sends a first request message to the first network server.

When the subscriber accesses through a 3GPP network, it would send an attachment request to the MME203; the MME203 would send an access authentication request message to the HSS201; the HSS201, after receiving the request, would perform subscriber access authentication, insert subscription data, authorize the subscriber to access PDN, etc., and then return an access authentication reply message to the MME203. In the present invention, the access authentication request message in the prior art acts as the first request message, while the access authentication reply message in the prior art acts as the first reply message; therefore, it would be unnecessary to add new interface.

When a subscriber accesses through a non-3GPP network, it will send an attachment request to the 3GPP AAA server 208; the 3GPP AAA server 208 would send a registration request to the HSS201; the HSS201, after receiving the registration request, would perform subscriber access authentication, insert subscription data, and authorize the subscriber to access PDN, etc., and then returns a registration reply message to the 3GPP AAA server. In the present invention, the registration request in the prior art acts as the first request message, while the registration reply message in the prior art acts as the first reply message; therefore, it would be unnecessary to add new interfaces.

In another embodiment, the second network server is MME203, which, after receiving the first reply message from the first network server, would further send the PCRF information to a third network server (not shown in the figure), i.e., sending a second request message containing the subscriber's identification information and the PCRF's identification information to the third network server, such that the third network server would send the subscriber-related message to the PCRF. Here, the third network server may be S-GW204 or P-GW205. In this way, irrespective of how many S-GWs or P-GWs are involved in a session or what geographical positions they are located at, as long as the request messages are about the same subscriber or the same subscriber group, these S-GWs or P-GWs will send the message to the same PCRF, such that these sessions will be controlled by the same PCRF.

In another embodiment, the second network server is a 3GPP AAA server 208, which, after receiving the first reply message from the first network server, would further send the PCRF information to a third network server (not shown in the figure), i.e., sending a second request message containing the subscriber's identification information and the PCRF's identification information to the third network server, such that the third network server would send the subscriber-related message to the PCRF. Here, the third network server may be P-GW205 or ePDG207. In this way, for a subscriber accesses through a non-3GPP network, irrespective of how many P-GWs or ePDGs are involved in a session or what geographical positions they are located at, as long as the request messages are about the same subscriber or the same subscriber group, these P-GWs or ePDGs will send the message to the same PCRF, such that these sessions will be controlled by the same PCRF.

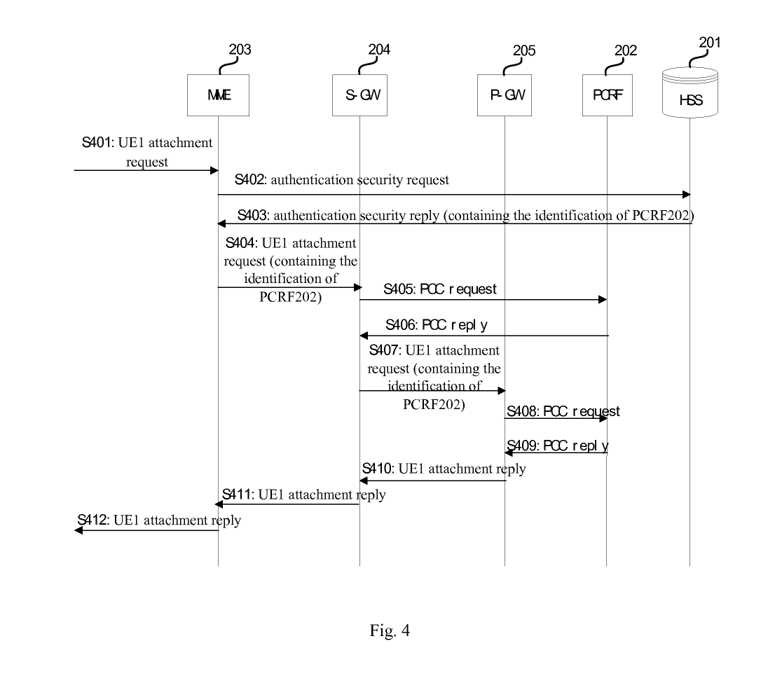

FIG. 4 shows a flow chart of a process of determining PCRF according to one embodiment of the present invention. In this embodiment, HSS201 stores subscriber configuration information containing preset correspondence relationship between subscribers and PCRFs, i.e., which PCRF each subscriber corresponds to. Hereinafter, its process will be described in detail with reference to FIG. 2.

In step S401, MME203 receives an attachment request from UE1 (not shown in FIG. 2); according to the 3GPP standard, the MME203 would send an access authentication request message to the HSS201 so as to authenticate the UE1 and obtain UE1's configuration information.

In step S402, the MME203 sends an access authentication request message to the HSS201, wherein the message contains UE1's identification information, for example, UE1's IMSI (International Mobile Subscriber Identification number).

According to the 3GPP standard, the HSS201, after receiving the access authentication request, would perform relevant authentication to UE1 and return the relevant configuration information of UE1. In the present invention, the HSS201 will further determine the PCRF corresponding to UE1 based on the UE1's identification and the preset correspondence relationships between subscribers and PCRFs. In this embodiment, the HSS201 determines that the PCRF corresponding to UE1 is PCRF202.

In step S403, the HSS201 sends an access authentication reply message to the MME203, wherein the message contains the identification information of the PCRF corresponding to UE1 (i.e., PCRF202). The identification information here may be the name or address of the PCRF.

The MME203 will further send the obtained PCRF202 identification information to the S-GW204 or P-GW205.

In step S404, the MME203 sends an attachment request of the UE1 to the S-GW204, wherein the request contains the identification information of the PCRF202, for indicating that the PCRF corresponding to the UE1 is PCRF202.

S-GW204, after receiving the message, would immediately know that the PCRF corresponding to the UE1 is PCRF202; then in subsequent use, the S-GW204 would send all Diameter messages related to UE1 to PCRF202, rather than other PCRF.

In step S405, the S-GW204 sends a PCC request to the PCRF202 to obtain policy and charging control information related to UE1.

In step S406, PCRF202 sends a PCC reply message to the S-GW204.

In step S407, the S-GW204 sends an attachment request of the UE1 to the P-GW205, wherein the request contains the identification information of the PCRF202, for indicating that the PCRF corresponding to the UE1 is PCRF202.

P-GW205, after receiving the message, would immediately know that the PCRF corresponding to the UE1 is PCRF202; then in subsequent use, the P-GW205 would send all Diameter messages related to UE1 to PCRF202, rather than other PCRF.

In step S408, the P-GW205 sends a PCC request to the PCRF202 to obtain policy and charging control information related to UE1.

In step S409, PCRF202 sends a PCC reply message to the P-GW205.

In step S410, P-GW205 sends the attachment reply message of the UE1 to the S-GW204.

In step S411, S-GW204 sends the attachment reply message of the UE1 to the MME203.

In step S412, MME203 sends the attachment reply message of the UE1 to UE1.

In this embodiment, since the correspondence relationship between subscribers and PCRFs has been preset in HSS201, through MME203 querying HSS201 about the PCRF corresponding to the UE1 and the obtained PCRF information being further notified to S-GW204 and P-GW205, the S-GW204 and P-GW205 are enabled to know that the PCRF corresponding to the UE1 is PCRF202; then, S-GW204 and P-GW205 will send all messages related to the UE1 as required to be sent to the PCRFs to the PCRF 202 in the later usage; in this way, it may be implemented that all sessions related to UE1 are uniformly controlled by the same PCRF, thereby solving the problems in the prior art.

Besides, this embodiment employs the messages and interfaces already existing in the prior art, such that it would be unnecessary to add new messages and interfaces, and the implementation would be very convenient.

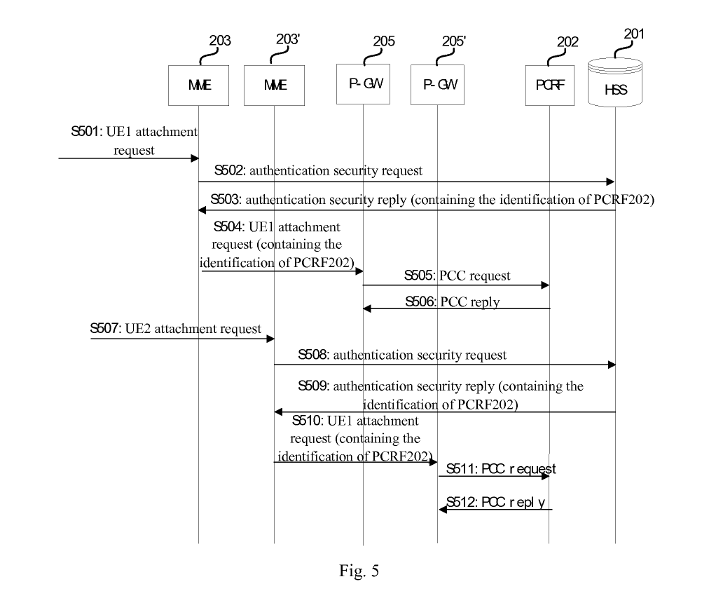

FIG. 5 shows a diagram of a process for determining PCRF according to another embodiment of the present invention. In this embodiment, HSS201 stores subscriber configuration information containing preset correspondence relationships between subscribers and PCRFs, i.e., which PCRF each subscriber corresponds to.

Hereinafter, the process will be described in detail with reference to FIG. 2. In this embodiment, UE1 (not shown in FIG. 2) and UE2 (not shown in FIG. 2) belong to the same subscriber group Group 1. UE1 is governed by MME203 and P-GW205, and UE2 is governed by MME203′ (not shown in FIG. 2) and P-GW205′ (not shown in FIG. 2). Subscribers belonging to Group 1 correspond to the same PCRF, i.e., PCRF202.

In step S501, MME203 receives an attachment request from UE1. According to the 3GPP standard, MME203 will send an access authentication request message to HSS201 so as to pass the authentication to UE1 and obtain UE1's configuration information.

In step S502, MME203 sends the access authentication request message to HSS201, wherein the message contains UE1's identification information, for example, the IMSI of UE1.

According to the 3GPP standard, HSS201, after receiving the access authentication request, will perform relevant authentication to UE1 and return the relevant configuration information of UE1 to MME203. In the present invention, HSS201 will further determine the PCRF corresponding to the UE1 based on the UE1's identification and the preset correspondence relationship between subscribers and PCRF. In this embodiment, HSS201 determines that the PCRF corresponding to UE1 is PCRF202.

In step S503, HSS201 sends an access authentication reply message to MME203, wherein the message contains the identification information of the PCRF corresponding to UE1, i.e., PCRF202. The identification information here may be the name or address of PCRF.

MME203 will further send the obtained identification information of PCRF202 to P-GW205.

In step S504, MME203 sends an attachment request of UE1 to P-GW205, wherein the request contains the identification information of PCRF202, for indicating that the PCRF corresponding to UE1 is PCRF202.

P-GW205, after receiving the message, would immediately know that the PCRF corresponding to UE1 is PCRF202; then in subsequent use, P-GW205 will send all Diameter messages related to UE1 to PCRF202, rather than other PCRFs.

In step S505, P-GW205 sends a PCC request to PCRF202 so as to obtain policy and charging control information related to UE1.

In step S506, PCRF202 sends a PCC reply message to P-GW205.

In step S507, MME203′ receives the attachment request from UE2. According to the 3GPP standard, the MME203′ will send an access authentication request to HSS201 so as to pass the authentication to UE2 and obtain the configuration information of UE2.

In step S508, MME203′ sends an access authentication request to HSS201, wherein the request contains identification information of UE2, for example, IMSI of UE2.

According to the 3GPP standard, HSS201, after receiving the access authentication request, will perform relevant authentication to UE2 and returns relevant configuration information of UE2 to MME203′. In the present invention, HSS201 will also determine the PCRF corresponding to UE2 based on the identification of UE2 and preset correspondence relationship between subscribers and PCRFs. In this embodiment, HSS201 determines that the PCRF corresponding to UE2 is PCRF202.

In step S509, HSS201 sends an access authentication reply message to MME203′, wherein the message contains the identification information of the PCRF (i.e., PCRF202) corresponding to UE2. The identification information here may be the name or address of PCRF.

MME203′ will further send the obtained identification information of PCRF202 to P-GW205′.

In step S510, MME203′ sends the attachment request of UE2 to P-GW205′, wherein the request contains identification information of PCRF202, for indicating that the PCRF corresponding to UE2 is PCRF202.

P-GW205′, after receiving the message, would immediately know that the PCRF corresponding to UE2 is PCRF202; then in subsequent use, P-GW205′ will send all Diameter messages related to UE2 to PCRF202, rather than other PCRFs.

In step S511, P-GW205′ sends a PCC request to PCRF202, for obtaining policy and charging control information related to UE2.

In step S512, PCRF202 sends a PCC reply message to P-GW205′.

In this embodiment, since the HSS201 presets the correspondence relationships between subscribers and PCRFs and subscribers belonging to the same subscriber group are provided with the same PCRF, the P-GW205 and P-GW205′ would know that the PCRFs corresponding to UE1 and UE2 are both PCRF202 by means of the MME203 and MME203′ querying to the HSS201 the PCRF corresponding to UE1 and the PCRF corresponding to UE2 and further notifying the obtained PCRF information to P-GW205 and P-GW205′. Then, P-GW205 would send to PCRF202 all messages related to UE1 as required to be sent to the PCRF in later use. Moreover, P-GW205′ will also send to PCRF 202 all messages related to UE2 as required to be sent to PCRF. In this way, it would be realized that relevant sessions of all subscribers in the same subscriber group will be uniformly controlled by the same PCRF, thereby solving the problems in the prior art.

Moreover, the embodiments all adopt the existing messages and interfaces in the prior art, without the need of adding new messages and interfaces; therefore, the implementation would be very convenient.

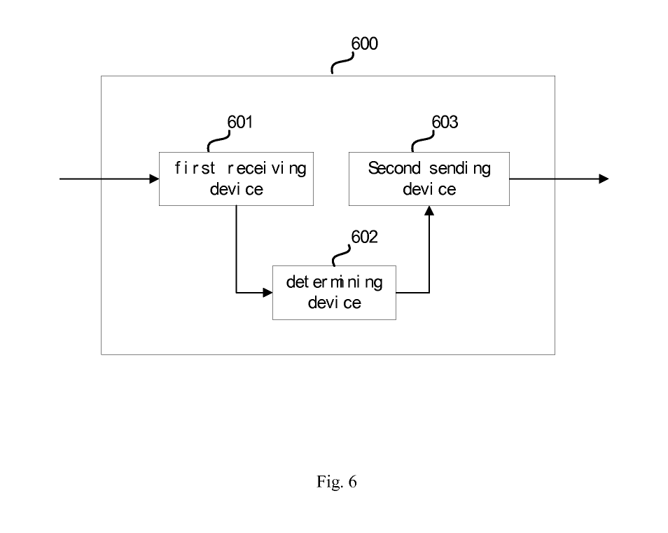

FIG. 6 shows a diagram of an apparatus for determining PCRF according to one embodiment of the present invention. The apparatus 600 comprises the first receiving device 601, the determining device 602 and the first sending device 603.

Combined with FIG. 2 and FIG. 3, the detailed descriptions about the working processes of the apparatus 600 would be given as follow.

In this embodiment, a first network server stores subscriber-relevant information. Such information includes preset correspondence information between the subscribers and the PCRFs, i.e., which PCRF each subscriber corresponds to; for subscribers belonging to the same subscriber group, they correspond to the same PCRF. In one embodiment, the first network server is HSS201. Those skilled in the art should understand that the first network server may also be other network element storing subscriber information, for example, SPR, etc.

Firstly, the first receiving device 601 receives a first request message including identifier information of a subscriber from the second network server. The second network server sending the request message to the first network server so as to obtain PCRF may be MME203 or AF206 or 3GPP AAA server 208.

Then, the determining device 602 determines the PCRF corresponding to the subscriber based on the subscriber's identification information and the preset correspondence relationship between subscribers and PCRFs.

Next, the first sending device 603 sends a first reply message including the identification information of the determined PCRF to the second network server. The second network server may use the PCRF information where necessary, i.e., sending the PCC request related to said subscriber to the PCRF. For example, for AF 206, the network elements in the IMS may send a message related to a certain subscriber to the same PCRF so as to guarantee that QoS and IP bearer are controlled by the same PCRF.

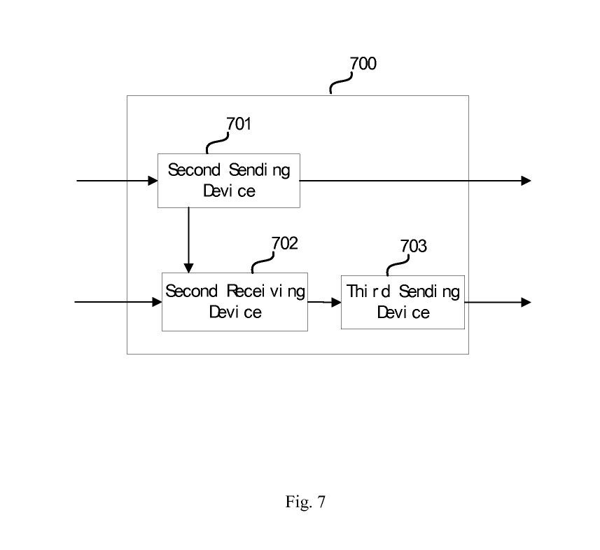

FIG. 7 shows a diagram of an apparatus for determining PCRF in a second network server according to one embodiment of the present invention. The apparatus 700 comprises the second sending device 701 and the second receiving device 702.

Combined with FIG. 2 and FIG. 3, the detailed descriptions about the working processes of the apparatus 700 would be given as follow. Wherein, the second network server may be MME203 or AF206 or 3GPP AAA server 208.

The second sending device 701 is used for sending a first request message containing identification information of a subscriber to a first network server. In this embodiment, a first network server stores subscriber-relevant information. Such information includes preset correspondence information between the subscribers and the PCRFs, i.e., which PCRF each subscriber corresponds to; for subscribers belonging to the same subscriber group, they correspond to the same PCRF. In one embodiment, the first network server is HSS201. Those skilled in the art should understand that the first network server may also be other network element storing subscriber information, for example, SPR, etc.

The second receiving device 702 is used for receiving said first reply message including the identification information of the determined PCRF from said second network server. The second network server may use the PCRF information where necessary, i.e., sending the PCC request related to said subscriber to the PCRF. For example, for AF 206, the network elements in the IMS may send a message related to a certain subscriber to the same PCRF so as to guarantee that QoS and IP bearer are controlled by the same PCRF.

In one embodiment, said second network server is MME203 or 3GPP AAA server 208, the second sending device 701 is further used to response to an attachment request from the subscriber and send a first request message to the first network server.

When the subscriber accesses through a 3GPP network, it would send an attachment request to the MME203; the second sending device 701 would send an access authentication request message to the HSS201; the HSS201, after receiving the request, would perform subscriber access authentication, insert subscription data, authorize the subscriber to access PDN, etc., and then return an access authentication reply message to the second receiving device 702. In the present invention, the access authentication request message in the prior art acts as the first request message, while the access authentication reply message in the prior art acts as the first reply message; therefore, it would be unnecessary to add new interface.

When a subscriber accesses through a non-3GPP network, it will send an attachment request to the 3GPP AAA server 208; the second sending device 701 would send a registration request to the HSS201; the second sending device 701, after receiving the registration request, would perform subscriber access authentication, insert subscription data, and authorize the subscriber to access PDN, etc., and then returns a registration reply message to the second receiving device 702. In the present invention, the registration request in the prior art acts as the first request message, while the registration reply message in the prior art acts as the first reply message; therefore, it would be unnecessary to add new interfaces.

In another embodiment, said second network server is MME203, said apparatus 700 also contains the third sending device 703. After the second receiving device 702 receiving the first reply message from the first network server, the third sending device 703 would further send the PCRF information to a third network server (not shown in the figure), i.e., sending a second request message containing the subscriber's identification information and the PCRF's identification information to the third network server, such that the third network server would send the subscriber-related message to the PCRF. Here, the third network server may be S-GW204 or P-GW205. Therefore, irrespective of how many S-GWs or P-GWs are involved in a session or what geographical positions they are located at, as long as the request messages are about the same subscriber or the same subscriber group, these S-GWs or P-GWs will send the message to the same PCRF, such that these sessions will be controlled by the same PCRF.

In another embodiment, said second network server is 3GPP AAA server 208 said apparatus 700 also contains the third sending device 703. After the second receiving device 702 receiving the first reply message from the first network server, the third sending device 703 would further send the PCRF information to a third network server (not shown in the figure), i.e., sending a second request message containing the subscriber's identification information and the PCRF's identification information to the third network server, such that the third network server would send the subscriber-related message to the PCRF. Here, the third network server may be S-GW204 or P-GW205. Therefore, irrespective of how many S-GWs or P-GWs are involved in a session or what geographical positions they are located at, as long as the request messages are about the same subscriber or the same subscriber group, these S-GWs or P-GWs will send the message to the same PCRF, such that these sessions will be controlled by the same PCRF.

It needs to note that the present invention can be implemented in software and/or a combination of software and hardware, for example, the invention can be implemented by using an Application Specific Integrated Circuit (ASIC), a general purpose computer or any other similar hardware equipment. In one embodiment, the software program of this invention can be executed by a processor to accomplish the aforesaid steps or functions. Likewise, the software program (including the relevant data structure) of the invention can be stored in a computer readable recording medium, for example, RAM memory, magneto-optical drive or floppy disk and similar devices. In addition, some steps or functions of the invention can be realized by using hardware, for example, a circuit that cooperates with the processor to perform various steps or functions.

In addition, part of the invention can be applied as a computer program product, such as a computer program instruction, when the instruction is executed by the computer, the method and/or technical solution according to this invention may be called or provided through an operation of the computer. However, the program instruction for calling the method of the invention may possibly be stored in a fixed or movable recording medium, and/or be transmitted via broadcasting or other signal carrier mediums, and/or be stored in the operation memory of a computer device that is running according to said program instruction. Here, there is one device included according to an embodiment of the invention, said device comprises a memory for storing computer program instructions and a processor for executing program instructions, this device is triggered to operate the methods and/or technical solutions based on the aforesaid embodiments of the invention when the computer program instructions are executed by said processor.

To those skilled in the art, apparently the present invention is not limited to the details of the aforementioned exemplary embodiments, moreover, under the premise of not deviating from the spirit or fundamental characteristics of the invention, this invention can be accomplished in other specific forms. Therefore, the embodiments should be considered exemplary and non-restrictive no matter from which point, the scope of the invention is defined by the appended claims instead of the above description, and aims at covering the meanings of the equivalent components falling into the claims and all changes within the scope in this invention. Any reference sign in the claims shall not be deemed as limiting the concerned claims. Besides, apparently the word “comprise/include” does not exclude other components or steps, singular numbers does not exclude complex numbers, the plurality of components or means mentioned in device claims may also be accomplished by one component or means through software or hardware, the wording like first and second are only used to represent names rather than any specific order.

1. A method of determining PCRF in a first network server, said first network server storing information related to subscribers, the method comprising the following steps:
receiving a first request message containing identification information of a subscriber from a second network server;
determining a PCRF corresponding to the subscriber based on preset correspondence relationships between subscribers and PCRFs;
sending a first reply message containing identification information of the determined PCRF to said second network server;
wherein the first network server pre-stores the correspondence relationships between subscribers and PCRFs.

2. The method according to claim 1, wherein the first network server is a Home Subscriber Server (HSS) or Subscriber Profile Repository (SPR), said second network server is a Mobility Management Entity (MME) or an Application Function (AF) or a 3GPP AAA server.

3. A method of determining PCRF in a second network server, comprising the following steps:
sending a first request message containing identification information of a subscriber to a first network server;
receiving a first reply message containing identification information of the PCRF corresponding to the subscriber from the first network server;
wherein, said first network server pre-stores correspondence relationships between subscribers and PCRFs.

4. The method according to claim 3, wherein said first network server is a Home Subscriber Server (HSS) or a Subscriber Profile Repository (SPR), and said second network server is a Mobility Management Entity (MME) or an Application Function (AF) or a 3GPP AAA server.

5. The method according to claim 4, wherein when the second network server is a mobility management entity (MME) or a 3GPP AAA server, the step of sending a first request message to the first network server further comprises:
sending a first request message to the first network server in response to an attachment request from the subscriber.

6. The method according to claim 4, wherein when the second network server is a mobility management entity (MME) or a 3GPP AAA server, after said step of receiving a first reply message from said first network server, further comprising:
sending a second request message containing said identification information of the subscriber and identification information of the PCRF to a third network server.

7. The method according to claim 6, wherein the third network server is a Service Gateway (S-GW) or a Packet Data Network Gateway (P-GW) or an Evolved Packet Data Gateway (ePDG).

8. An apparatus of determining PCRF in a first network server, said first network server stores information related to subscribers, the apparatus comprises:
a first receiving device for receiving a first request message containing identification information of a subscriber from a second network server;
a determining device for determining a PCRF corresponding to the subscriber based on preset correspondence relationships between subscribers and PCRFs;
a first sending device for sending a first reply message containing identification information of the determined PCRF to said second network server;
wherein said first network server pre-stores the correspondence relationships between subscribers and PCRFs.

9. The apparatus according to claim 8, wherein said first network server is a Home Subscriber Server (HSS) or Subscriber Profile Repository (SPR), said second network server is a Mobility Management Entity (MME) or an Application Function (AF) or a 3GPP AAA server.

10. An apparatus of determining PCRF in a second network server, which comprises:
a second sending device for sending a first request message containing identification information of a subscriber to a first network server;
a second receiving device for receiving a first reply message containing identification information of the PCRF corresponding to said subscriber from said first network server;
wherein said first network server pre-stores correspondence relationships between subscribers and PCRFs.

11. The apparatus according to claim 10, wherein said first network server is a Home Subscriber Server (HSS) or Subscriber Profile Repository (SPR), the second network server is a Mobility Management Entity (MME) or an Application Function (AF) or a 3GPP AAA server.

12. The apparatus according to claim 11, wherein, when said second network server is a Mobility Management Entity (MME) or a 3GPP AAA server, said second network server is also used for sending a first request message to the first network server in response to an attachment request from said subscriber.

13. The apparatus according to claim 11, wherein, when said second network server is a Mobility Management Entity (MME) or a 3GPP AAA server, said apparatus comprises a third sending device, used for sending a second request message containing identification information of the subscriber and identification information of the PCRF to a third network server after the step of the second receiving device receiving a first reply message from said first network server.

14. The apparatus according to claim 13, wherein said third network server is a Service Gateway (S-GW) or a Packet Data Network Gateway (P-GW) or an Evolved Packet Data Gateway (ePDG).
